(19) United States
(12) Patent Application Publication
(10) Pub. No.: US 2004/0233212 A1
(43) Pub. Date: Nov. 25, 2004

(54) Method for generating color monitor profile for different operating systems

(76) Inventors: Chung-I Chang, Taipei Hsien (TW); Shin-Chang Chang, Taipei Hsien (TW); Linda Lin, Taipei Hsien (TW)

Correspondence Address: Chung-I Chang, 235 Chung-Ho, Box 8-24, Taipei, TW

(21) Appl. No.: 10/725,105

(22) Filed: Dec. 2, 2003

(30) Foreign Application Priority Data
May 23, 2003 (TW) 092114048

(51) Int. Cl. G09G 5/02

(52) U.S. Cl. 345/589

(57) ABSTRACT

A method for generating a color monitor profile for different operating system comprises the steps of: building a multimedia film for a screen to be measured; playing the multimedia film on the screen; measuring hues, gray levels, and RGB values of the screen by using a color meter near the screen; transferring outputs from color meter to a computer having a color management softwear so as to build a color monitor profile for the computer. Thereby, it is unnecessary to develop another color management softwear to fit for the operating system used in the screen.

### FIELD OF THE INVENTION

The present invention relates to image processing, and particular to a method for generating a color monitor profile for different operating systems.

### BACKGROUND OF THE INVENTION

Currently, the conventional printing technique has been replaced by current electronic printing technology. However, in computer printing, it is necessary to match the colors output from a printer with colors displayed on the computer screen. Colors of the computer screen are generated by using the mixing RGB color elements, but the colors of printer are generated by CMYK. Thereby, according to the international ICC color committee, the bridge of the RGB and YMYK is based on the XYZ values (or laboratory values(LAB values). Thereby, the screen color monitor profile and printer color monitor profile are built for describing the color presentation of the screen and printer, respectively. Thus, the color relations between the screen and printer can be built so that the outputs of the screen and printer can be the same or similar

For example, if it is desired to generate the screen profile file, a color management software (CMS) is used to generate a specific image on a screen to be measured. Then a color meter is sued to capture the values of the hues, gray levels, and RGB. Then these values are converted to the XYZ valu used in the screen profile file. The way for generate a printer profile file is that the color management software causes the printer to output 928 color blocks from the PTRI of IT8. 7/3. Then above values are got by measuring the 928 color blocks.

However, the screen profile file and printer profile file are got from different operation system. For example, in PC window, the color management software must be suited the PC window. The same is for MAC computer or other kinds of computer. Thereby, the manufacturers must develop different color management software used for printer so that the printer can be connected to various computer operating systems for solving this problem.

### SUMMARY OF THE INVENTION

Accordingly, the primary object of the present invention is to provide a method for generating a color monitor profile for different operating systems comprising the steps of: building a multimedia film for a screen to be measured; playing the multimedia on the screen; measuring hues, gray levels, and RGB values of the screen by using a color meter near the screen; transferring outputs from color meter to a computer having a color management softwear so as to build a color monitor profile for the computer. Thereby, it is unnecessary to develop another color management softwear to fit for the operating system used in the screen.

The various objects and advantages of the present invention will be more readily understood from the following detailed description when read in conjunction with the appended drawing.

### BRIEF DESCRIPTION OF THE DRAWINGS

FIG. 1 is a schematic view showing the process for executing the method of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, profiles, and characteristics of the present invention, but not to be used to confine the scope and spirit of the present invention defined in the appended claims.

The color profile of the present invention is provided by a color management software for a predetermined operation system, but it can be used to screens of different operation system. Thereby, the manufacturers are not necessary to develop different color management software to be used in printers for various operation systems.

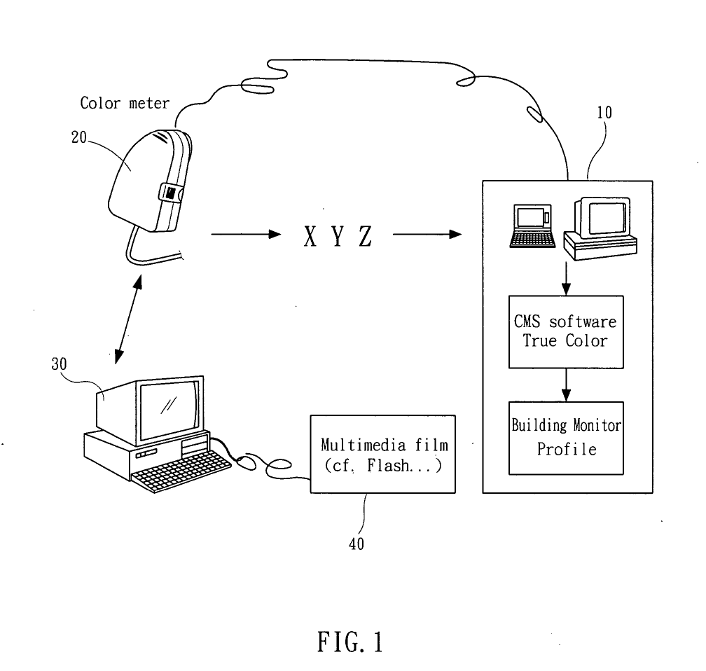

With reference to FIG. 1, a color management software (CMS) of a PC system is illustrated, which is used to build a screen profile to a MAC computer. Likewise, it can be used to other screens using other operation systems. In the drawing, a personal computer 10 (or a notebook computer) having a color management software (CMS), a MAC computer 30 to be measured, a calorimeter 20 placed near the MAC computer 30, and a multi-media film 40 are included. The multi-media film 40 is dedicated to the MAC computer 30 so that the screen can display desired colors. Next, the screen outputs desired hues, gray levels, and RGB values to the personal computer 10 performing the color management software. Thereby, the color management software will build the screen profile file of the MAC computer 30.

The operation of the present invention in a PC platform will be described herein. A true color monitor profile software will be performed. The colorimeter 20 will measure the profiles of hues, gray levels, and RGB values. A mode for building the screen profile is selected for generating a color profile of the screen. Then, the hues, gray levels, and RGB values are used to build a multi-media software to be stored in the MAC platform. However, by the present invention, the color profile can be used to screen in the computer using other operation system instead of only being suitable for the original operation system.

The present invention provides a method for generating a color monitor profile for different operating system. Firstly, a multimedia film 40 is built for the screen 30 to be measured; playing the multimedia film 40 on the screen; measuring hues, gray levels, and RGB values of the screen 30 by using a color meter 20 near the screen 30; transferring outputs from color meter 20 to the computer 10 having a color management softwear so as to build a color monitor profile for the computer 10. Thereby, it is unnecessary to develop another color management softwear to fit for the operating system used in the screen.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for generating a color monitor profile for different operating systems; comprising the steps of:
building a multimedia film for a screen to be measured;
playing the multimedia film on the screen;
measuring hues, gray levels, and RGB values of the screen by using a color meter near the screen;
transferring outputs from color meter to a computer having a color management softwear so as to build a color monitor profile for the computer.

2. The method for generating a color monitor profile for different operating system as claimed in claim 1, wherein the screen to be measured is any operating system currently used.

3. The method for generating a color monitor profile for different operating system as claimed in claim 1, wherein the operating system of the computer executing the color management softwear is different from that used to the screen to be measured.
